(19) United States
(12) Patent Application Publication
(10) Pub. No.: US 2014/0048343 A1
(43) Pub. Date: Feb. 20, 2014

(54) MULTI-AXIS ARTICULATING CRAWLER

(71) Applicants: Darth Christopher Fitch, Jackson, NJ (US); Christopher Taylor Hill, Point Pleasant, NJ (US)

(72) Inventors: Darth Christopher Fitch, Jackson, NJ (US); Christopher Taylor Hill, Point Pleasant, NJ (US)

(73) Assignee: HILMAN, INCORPORATED, Marlboro, NJ (US)

(21) Appl. No.: 13/588,509

(22) Filed: Aug. 17, 2012

(51) Int. Cl. B62D 55/065

(52) U.S. Cl. 180/9.1

(57) ABSTRACT

A multi-axis articulating crawler includes a turntable assembly having a turntable, a first main beam rotatably coupled to a first side of the turntable assembly and a second main beam rotatably coupled to a second side of the turntable assembly. First and second track assemblies are rotatably coupled to the first main beam, and third and fourth track assemblies are rotatably coupled to the second main beam. The axes of rotation of the first, second, third and fourth track assemblies are perpendicular to the axis of rotation of the first and second arms. The longitudinal axes of the first and third track assemblies are on the same line and the longitudinal axes of the second and fourth track assemblies are on the same line. The track assemblies are independently driven to maneuver the crawler.

### FIELD OF THE INVENTION

This invention relates to crawlers that are capable of transporting heavy objects, and more particularly to such crawlers that have one or more tread assemblies that engage the ground or another surface to propel the crawler.

### BACKGROUND

Heavy objects must be transported in various and diverse environments, including manufacturing and repair facilities. However, transporting heavy loads is a difficult and often time consuming undertaking due to the weight of the object(s) and also often due to the bulkiness of the object(s). A transporter for transporting the heavy loads must be strong enough to support the weight of the object(s) and preferably is as low to the ground as possible so that the heavy loads to be transported need only be lifted a minimum amount to be loaded on the transporter and so that the transporter and load combination have as low a center of gravity as possible. It is desired to transport such heavy objects as time efficiently as possible, with as little machinery as possible, and as safely as possible.

Typically, a transporter for heavy objects has one or more tread assemblies that are attached to and support a central carrier member. The carrier member provides a surface for the heavy object(s) to be placed upon and the one or more tread assemblies propel the transporter along the ground or other surface. The direction of movement of the tread assembly or assemblies define the path and direction of the transporter.

However, the ground or other surface that such transporters traverse may have irregularities or may be fully or partially sloped. Such irregularities or slopes may cause the use of conventional heavy object transporters to be even more time-consuming and difficult, and less efficient.

Another problem is that some conventional transporters are not very maneuverable. Those transporters can move in straight lines, but have difficulty in making turns and/or rotating. As a result, those conventional transporters often must be turned by applying an external force to rotate the transporters, or they can be driven in a very large arc.

Thus, a need still exists for an efficient crawler for transporting and maneuvering heavy loads.

### SUMMARY

In some embodiments of this invention, the crawler includes a load support, a first arm rotatably attached to the load support and located on one side of the load support, a second arm also rotatably attached to the load support, first and second spaced track assemblies rotatably attached to the first arm, and third and fourth spaced track assemblies rotatably attached to the second arm. The second arm may be located on the opposite side of the load support from the first arm. The second arm may be capable of rotating relative to the load support independent of the rotation of the first arm relative to the load support. The axis of rotation of the first arm relative to the load support may be parallel to the axis of rotation of the second arm relative to the load support. The axes of rotation of the first, second, third and fourth track assemblies relative to the first and second arms may be perpendicular to the axes of rotation of the first and second arms relative to load support. The first, second, third and fourth track assemblies may extend below the load support and the first and second arms.

In other embodiments of this invention, the load support may include a turntable, with the turntable defining the uppermost surface of the load support and extending above the first and second arms and the first, second, third and fourth track assemblies.

In yet other embodiments, the axes of rotation of the first arm and the second arm relative to the load support may be the same.

In further embodiments, the first arm and the second arm may be elongated arms that have respective longitudinal axes. Those longitudinal axes may be parallel but located on opposite sides of the load support. In addition, the axes of rotation of the first and second arms relative to the load support may be perpendicular to the longitudinal axes of the first and second arms.

In yet other embodiments, the first and second track assemblies may have the same axis of rotation and the third and fourth track assemblies may have the same axis of rotation.

In additional embodiments, the first, second, third and fourth track assemblies may each include a tread assembly having a longitudinal axis in the direction of movement of the tread assembly. The longitudinal axes of the tread assemblies of the first and third track assemblies may be on the same line and longitudinal axes of the tread assemblies of the second and fourth track assemblies may be on the same line.

In further embodiments, the first and third track assemblies may be located on an opposite side of the load support from the second and fourth track assemblies.

In yet other embodiments, each of the tread assemblies of the first, second, third and fourth track assemblies may include a drive roller, at least one other roller, and a continuous tread. The continuous tread may form a loop around the drive roller and the at least one other roller. The continuous tread may be comprised of a continuous series of elongated tread pads arranged in parallel. The tread pads may be oriented perpendicular to the longitudinal axis of the tread assembly.

In other embodiments, the crawler may include motors that drive the drive rollers of the tread assemblies.

In further embodiments, each of the first, second, third and fourth track assemblies may include a frame that partially encloses the tread assembly. The frame may include a rod that is rotatably received by one of the first arm and second arm. The drive roller and at least one of the other rollers may be rotatable relative to the frame.

In yet other embodiments, each of the tread assemblies of the first, second, third and fourth tread assemblies may include a roller pack assembly located within the loop formed by the continuous tread. The roller pack assembly may be rotatable about a pitch axis and a roll axis. The pitch axis may be spaced from but parallel to the axis of rotation of the drive roller and also may be perpendicular to the roll axis. The roller pack assembly includes bearing members that may rotate about axes parallel to the pitch axis and may selectively engage the tread.

In further embodiments, the roller packet assembly may include a central rod that extends the width of the frame and may have ends that are rotatably received by the frame. The roller pack assembly may also include forward and aft axles on opposite sides of the central rod. The central rod, the forward axle and the aft axle may have longitudinal axes located in parallel planes.

In this manner, this invention provides crawlers that are compact, modular and self-propelled, have a high load carrying capacity, and reduce the time and machinery necessary to transport heavy loads. The multi-axis articulating crawlers of this invention are able to transport heavy object(s) over uneven surfaces and imperfections in the surfaces.

Other advantages, benefits and features of the present invention will become apparent to those skilled in the art upon reading the detailed description of the invention.

### BRIEF DESCRIPTION OF THE DRAWINGS

FIG. 1 is a top perspective view of a multi-axis articulating crawler according to one embodiment of this invention.

FIG. 2 is a bottom view of the multi-axis articulating crawler illustrated in FIG. 1.

FIG. 3 is a top perspective view of the multi-axis articulating crawler illustrated in FIGS. 1 and 2 with selected components removed for clarity, and also illustrating some of the axes of articulation.

FIG. 4 is a top perspective view of the turntable and main beam assemblies of the multi-axis articulating crawler illustrated in FIGS. 1-3, and also illustrating one of the axes of articulation.

FIG. 5 is a top perspective, exploded view of a main beam assembly of the multi-axis articulating crawler illustrated in FIGS. 1-3.

FIG. 6 is a top perspective, exploded view of the turntable assembly of the multi-axis articulating crawler illustrated in FIGS. 1-3, and also illustrating one of the axes of articulation.

FIG. 7 is a top perspective, partially exploded view of a track assembly of the multi-axis articulating crawler illustrated in FIGS. 1-3.

FIG. 8 is a top perspective view of the tread assembly illustrated in FIG. 7 with selected components removed for clarity.

FIG. 9 is a top perspective, exploded view of a roller pack assembly of the tread assembly illustrated in FIG. 8.

FIG. 10 is a top perspective, exploded view of the tread and chains of the tread assembly illustrated in FIGS. 7 and 8.

FIGS. 11A-11C are schematic drawings of the use of multiple multi-axis articulating crawlers illustrated in FIGS. 1-10 to transport a load.

FIG. 12 is a side perspective view of a drive shaft assembly of the tread assembly illustrated in FIGS. 7 and 8.

FIG. 12A is an exploded view of the drive shaft assembly of FIG. 12.

FIG. 13 is a simplified schematic drawing of a control system for an individual multi-axis articulating crawler according to this invention or for a plurality of such crawlers working in unison.

### DETAILED DESCRIPTION OF EMBODIMENTS

Referring to the accompanying figures, multi-axis articulating crawlers according to the invention will be described.

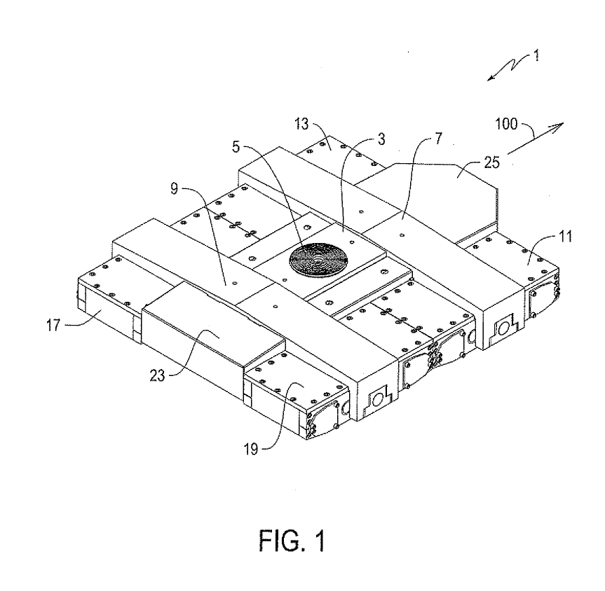

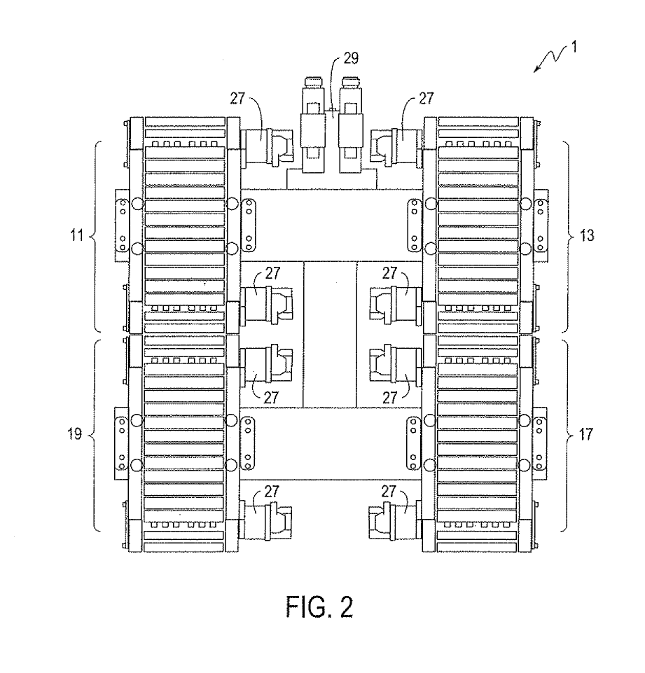

A multi-axis articulating crawler (MAC) 1 is illustrated in FIGS. 1-3. In this embodiment, the MAC 1 includes a turntable assembly 3 having a turntable 5, a first main beam assembly 7 coupled to a first side of the turntable assembly 3, a second main beam assembly 9 coupled to a second side of the turntable assembly 3, a first pair of track assemblies 11, 13 coupled to the first main beam assembly 7, a second pair of track assemblies 17, 19 coupled to the second main beam assembly 9, a rear cover plate 23, a front cover plate 25, motors 27, and a manifold 29.

The MAC 1 may be made of steel, any other material, or any combination of materials with high strength that does not substantially deform under heavy loads.

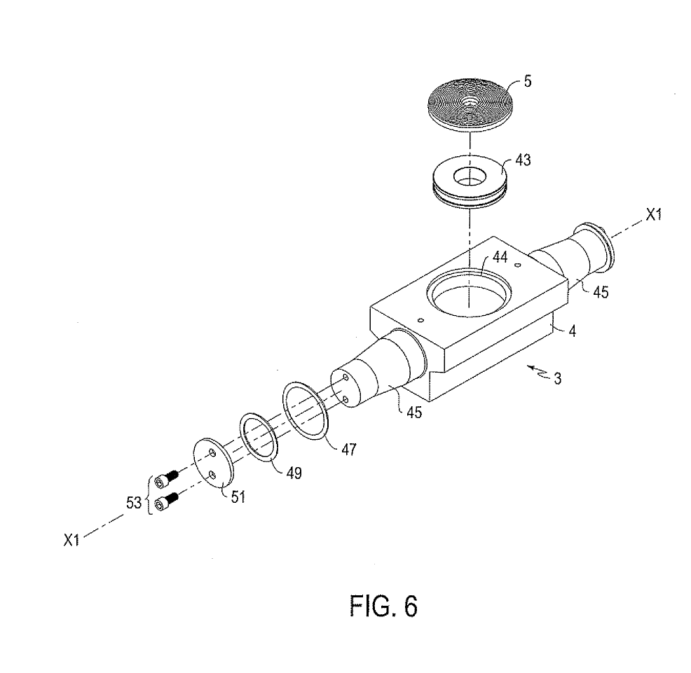

Referring to FIGS. 1, 3 and 4, the turntable assembly 3 is disposed between the first main beam assembly 7 and the second main beam assembly 9. Referring to FIG. 6, in this embodiment, the turntable assembly 3 includes, in addition to the turntable 5, a turntable base 4, a turntable bearing 43, two extending portions 45, first washers 47, second washers 49, base caps 51 and screws 53. The two extending portions 45 can be integrated with the turntable base 4, or separate work pieces fixedly attached to the turntable base 4. The turntable assembly 3 has longitudinal and lateral axes. The lateral axis is the axis through the two extending portions 45. The longitudinal axis is perpendicular to the lateral axis.

Also in this embodiment, the turntable base 4 has a generally rectangular shape and the turntable 5 has a generally circular shape. In other embodiments, the turntable base 4 and turntable 5 may be of any shape and size that can support the heavy loads to be transported without risk of the MAC 1 tilting if a load is not centered on the turntable 5. Further, while this embodiment includes one turntable 5, other embodiments may have multiple turntables 5 of the same or different shape and size.

The turntable base 4 includes a top circular recess 44. The turntable bearing 43 is received within the circular recess 44, such that the turntable bearing 43 is disposed between the turntable 5 and the top surface of the turntable base 4. The turntable bearing 43 allows the turntable 5 to rotate relative to the turntable base 4.

The two extending portions 45 extend from the turntable base 4 in opposite lateral directions. The extending portions 45 are generally cylindrical and taper as they extend away from the turntable base 4. The extending portions 45 may have other shapes in other embodiments of the invention. The first and second main beam assemblies 7 and 9 are rotatably attached to the extending portions 45, as discussed below.

Each of the extending portions 45 has a first washer 47 and a second washer 49 disposed around it. The first and second washers 47, 49 are concentric with the extending portions 45.

A base cap 51 is attached on the end of each extending portion 45, by screws 53, to retain the first and second main beam assemblies 7, 9 on extending portions 45, as discussed below. While this embodiment utilizes screws 53 to attach the base caps 51 to the extending portions 45, any other type of suitable fastening means can be used to attach the base caps 51 to the extending portions 45.

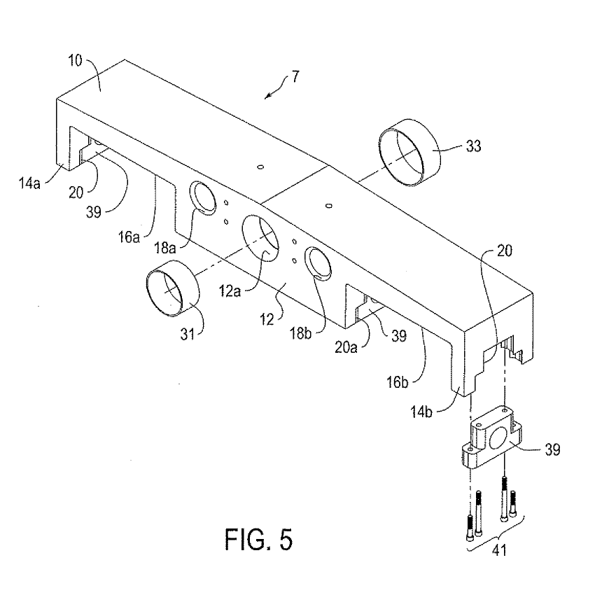

Referring to FIG. 5, in this embodiment, the first main beam assembly 7 includes a base beam 10, concentric bearings 31, 33, bushing blocks 39 and screws 41.

The base beam 10 has a central portion 12, two end portions 14a and 14b, and two slotted portions 16a and 16b aligned along the transverse direction. The slotted portions 16a and 16b are between the central portion 12 and the end portions 14a and 14b, respectively. The slotted portion 16a receives the track assembly 11, and the slotted portion 10 receives the track assembly 13.

The central portion 12 has a central aperture 12a in which the two concentric bearings 31, 33 are disposed. The bearing 31 has a smaller diameter than the bearing 33. An extending portion 45 is rotatably received within the central aperture 12a and the bearings 31, 33, as discussed below.

The central portion 12 also has two side apertures 18a and 18b. The side apertures 18a and 18b receive the wires, hoses, etc. which run to the motors 27.

The end portions 14a and 14b each have a receiving indent 20. In addition, each outer wall of the central portion 12 includes a receiving indent 20a that is of the same size and shape as the receiving indents 20. The first main beam assembly 7 includes four bushing blocks 39, one of which is received in each receiving indent 20 and 20a and attached thereto by screws 41. See FIGS. 4 and 5.

The central rods 58 of the track assemblies 11, 13, 17, 19 are received in and rotatably supported by bushing blocks 39, as discussed below.

The second main beam assembly 9 is similarly constructed. The slotted portions 16a and 16b of the second main beam assembly 9 receive the track assemblies 17 and 19, respectively.

While in this embodiment, the base beams 10 of the first and second main beam assemblies 7, 9 are essentially elongated beams that form an “H” with the turntable assembly 3, and have the apertures and slots discussed above, the base beams 10 can be of any shape and have whatever structural elements are necessary to adequately support the track assemblies 11, 13, 17, 19. Moreover, the bushing blocks 39 can be replaced by any other bearing or bushing members that permit rotation of the track assemblies 11, 13, 17, 19 relative to the base beams 10.

The first and second main beam assemblies 7 and 9 are rotatably connected to the turntable assembly 3, as described below.

One of the extending portions 45 of the turntable base 4 is received within the bearings 31, 33 and the central aperture 12a of the base beam 10 of the first main beam assembly 7. The other extending portion 45 is received within the bearings 31, 33 and the central aperture 12a of the base beam 10 of the second main beam assembly 9. Bearings 31 and 33 permit rotation of first and second main beam assemblies 7, 9 around their respective extending portions 45. The washers 47, 49 are located on the ends of the bearings 31, 33. The end caps 51 retain the first and second main beam assemblies 7, 9 on their respective extending portions 45 because the diameter of the end caps 51 is larger than the diameter of the central apertures 12a. See FIG. 4.

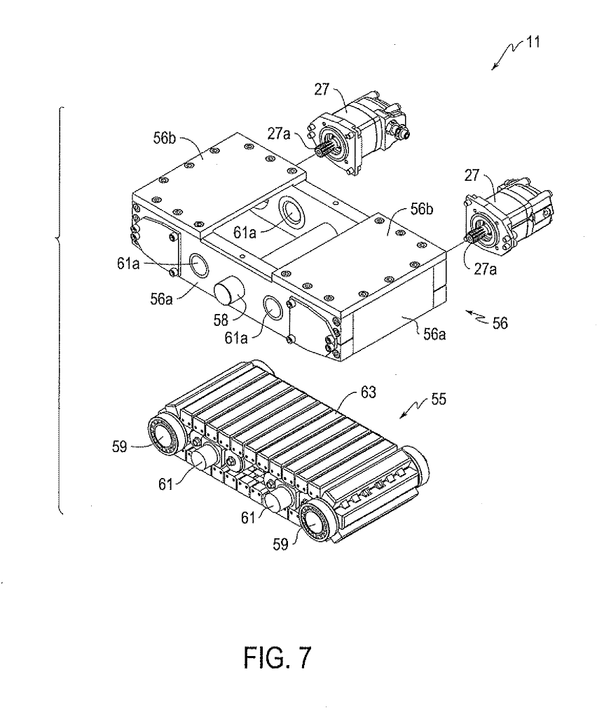

As stated, FIG. 7 is a top perspective, exploded view of one of the track assemblies, track assembly 11. The other track assemblies 13, 17 and 19 have the same construction as track assembly 11. The track assemblies 11, 13, 17, 19 have a modular construction, such that each are readily detachable from the MAC 1.

The track assembly 11 has a frame 56 and a tread assembly 55. In this embodiment, the frame 56 has a central rod 58, four side plates 56a, and two top plates 56b. Side plates 56a and top plates 56b form a partial enclosure that houses the tread assembly 55. The side plates 56a and top plates 56b may be attached to each other by screws, bolts and nuts, pins or welding, with or without braces, or fastened in any other manner known to one of ordinary skill in the art.

The central rod 58 is fixedly attached to the side plates 56a and extends out the side plates 56a. See FIG. 7. The ends of the central rod 58 are received in two of the bushing blocks 39 of the first main beam assembly 7, as discussed above. The receipt of the ends of the central rod 58 in bushing blocks 39 permits the entire track assembly 11 to rotate or articulate relative to first main beam assembly 7, as discussed in detail below.

The side plates 56a include apertures 56c which receive the drive shafts 27a of the motors 27.

The side plates 56a also include apertures 61 a that receive the ends of rods 65b of the roller pack assemblies 61, as described below.

While one specific configuration of the frame 56 is illustrated in the figures and described above, the frame 56 may be of any construction that adequately supports the tread assemblies 55.

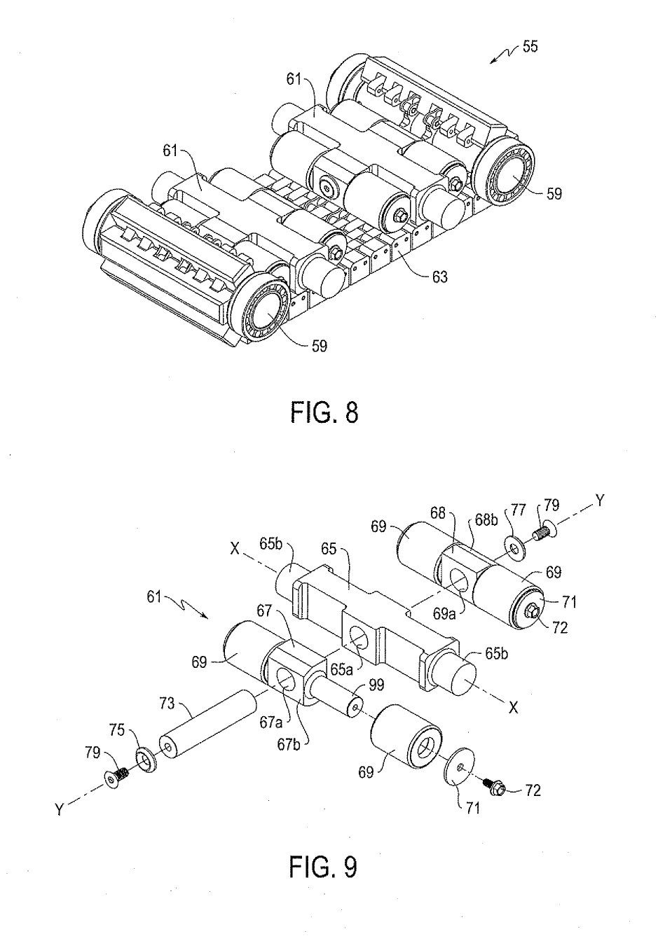

Referring to FIGS. 7 and 8, in this embodiment, the tread assembly 55 includes the tread 63, two drive shaft assemblies 59 and two roller pack assemblies 61. The tread 63 forms a continuous loop around the drive shaft assemblies 59. The two drive shaft assemblies 59 contact the tread 63 to drive the tread 63 in that loop, as discussed in detail below.

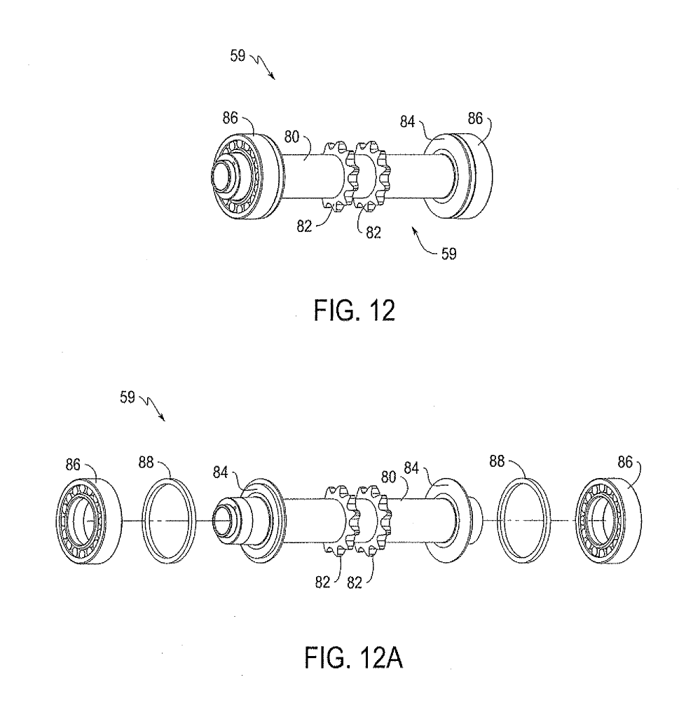

Referring to FIGS. 12 and 12A, in this embodiment, the drive shaft assemblies 59 each include a drive shaft 80, two sprockets 82, two bearing retainer plates 84, two bearings 86 and two bearing rings 88.

The sprockets 82 and the bearing retainer plates 84 are integral with or fixedly attached to the drive shaft 80. There is a bearing 86 and a bearing ring 88 on each end of the drive shaft 80. The bearing retainer plates 84 restrict inward movement of the bearings 86 and the bearing rings 88. The bearings 86 permit rotational movement of the drive shaft 80, the sprockets 82 and the bearing retainer plates 84 relative to the frame 56.

While in this embodiment, the two drive shaft assemblies 59 are located at the ends of the loop formed by the tread 63, in other embodiments, there may be a drive shaft assembly between the ends of the loop formed by the tread 63, with additional driven or idler drive shaft assemblies at the ends of the loop. Also, in this embodiment, the loop is oval-shaped. In other embodiments, the loop can have a different shape.

Also, while in this embodiment, there are two roller pack assemblies 61 in each tread assembly 55, other embodiments of this invention may have more than two roller pack assemblies or only one roller pack assembly in their tread assemblies. The roller pack assemblies 61 are preferably disposed between and in close proximity to the drive shafts 59. The roller pack assemblies 61 increase bearing contact of the tread 63 with the ground or other surface, as discussed below.

Referring to FIG. 9, in this embodiment, each roller pack assembly 61 includes a main pivot block 65, a forward axle 67, an aft axle 68, a plurality of bearing elements 69, washers 71, screws 72, a central shaft 73, a front washer 75, a rear washer 77 and screws 79. The forward axle 67 and the aft axle 68 are connected to the main pivot block 65 on opposite sides of the main pivot block 65.

The main pivot block 65 generally has a rectangular shape with ends 65b that are cylindrical. An X axis for articulation of the roller pack assembly 61 is defined through approximately the center of the main pivot block 65 and extends in the traverse direction. See FIG. 9.

The forward axle 67 and the aft axle 68 include a central block 67b and 68b, respectively, each of which has rods 99 extending from opposite sides.

While in this embodiment, the main pivot block 65, the forward axle 67 and the aft axle 68 have the shapes and configurations illustrated and described above, those members may have other shapes and configurations in other embodiments.

The central shaft 73 is received within apertures 67a, 65a and 69a in the forward axle 67, the main pivot block 65, and the aft axle 68, respectively. A Y axis for articulation of the forward axle 67 and the aft axle 68 is defined through approximately the center of the central shaft 73. The forward axle 67 and the aft axle 68 can articulate about the Y axis independent of the main pivot block 65 and each other.

The front washer 75 and the rear washer 77 are attached to the opposite ends of the central shaft 73 by the screws 79. The front washer 75 and the rear washer 77 engage the outer walls of the forward axle 67 and the aft axle 68 to retain the central shaft 73 within the forward axle 67, the main pivot block 65, and the aft axle 68.

The bearing elements 69 are placed on the rods 99 of the front axle 67 and the aft axle 68. The bearing elements 69 are free to rotate relative to the rods 99. The washers 71 and the screws 72 retain the bearing elements 69 on their respective rods 99.

The bearing elements 69 selectively contact and “push on” the tread 63 (see FIG. 8) when the roller pack assembly 61 articulates around the X axis and/or one or both of the forward axle 67 and the aft axle 68 rotate around the Y axis, as described below.

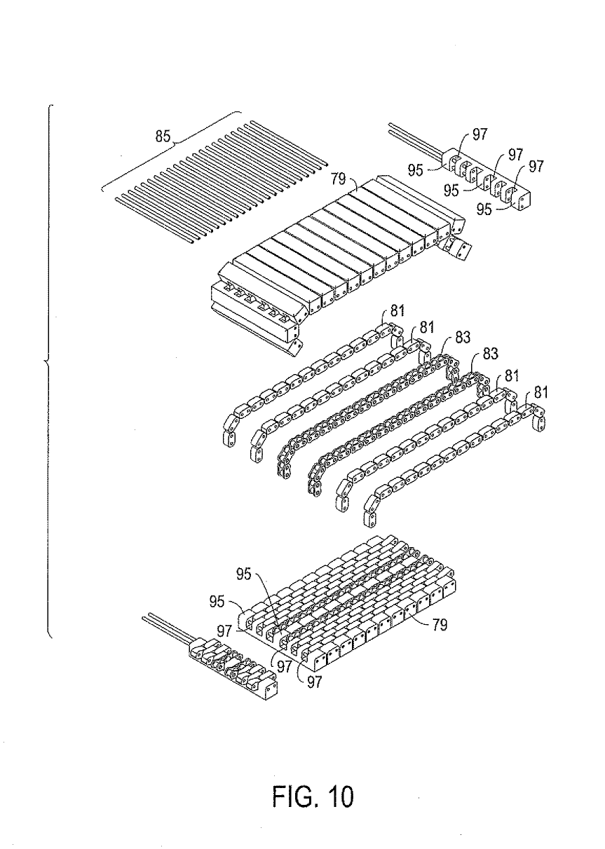

Referring to FIG. 10, in this embodiment, the tread 63 includes a series of tread pads 79, tread chains 81, tread driven chains 83 and interconnecting rods 85.

The tread pads 79 are elongated members, aligned along their long sides. Each tread pad 79 has a series of spaced walls 95 that define a plurality of slots 97. The slots 97 receive links of the tread chains 81 and the tread driven chains 83. The tread pads 79 may be one piece or multiple pieces constructed from steel or any other material, or combination of materials, suitable to support the load.

Each wall 95 of each tread pad 79 includes two holes. For a given tread pad 79, the two holes in each of its walls 95 are in alignment. Moreover, the two holes in each tread pad 79 are of the same size and spacing. Likewise, each link in the tread chains 81 and tread driven chains 83 also includes two holes of the same size and spacing as the two holes in the walls 95 of the tread pads 79. Rods 85 are inserted through the two holes in the walls 95 of the tread pads 79 and the two holes in the links of the tread chains 81 and tread driven chains 83 to interconnect the tread pads 79, the tread chains 81 and the tread driven chains 83.

The driven chains 83 engage and are driven by sprockets 82 of the drive shaft assemblies 59, as discussed below.

The motors 27 provide the motive force for the MAC 1. The motors 27 may be hydraulic motors, electric motors, or any other type of motor that is capable of providing the requisite torque. The motors 27 are reversible, such that MAC 1 can go forward or backward.

The motors 27 are attached to the side walls 56a of the frame 56 of the track assemblies 11, 13, 17, 19. See FIG. 7. The motors 27 include drive shafts 27a. The drive shafts 27a extend through the holes 56c in the side walls 56a of the frame 56 and are connected to the drive shafts 80 of the drive shaft assemblies 59 to propel the treads 63 in the desired direction, as discussed in more detail below.

The manifold 29 is included in the MAC 1 when it is a hydraulically operated device. The manifold 29 regulates the flow of hydraulic fluid to the various motors 27.

The rear cover plate 23 and the front cover plate 25 cover select components of the MAC 1, as illustrated in FIG. 1. Specifically, in this embodiment, two rear motors 27 are covered by the rear cover plate 23 and two front motors 27 and the manifold 29 are covered by the front cover plate 25. Motors not located beneath the rear and front cover plates 23, 25 may be covered by other plates.

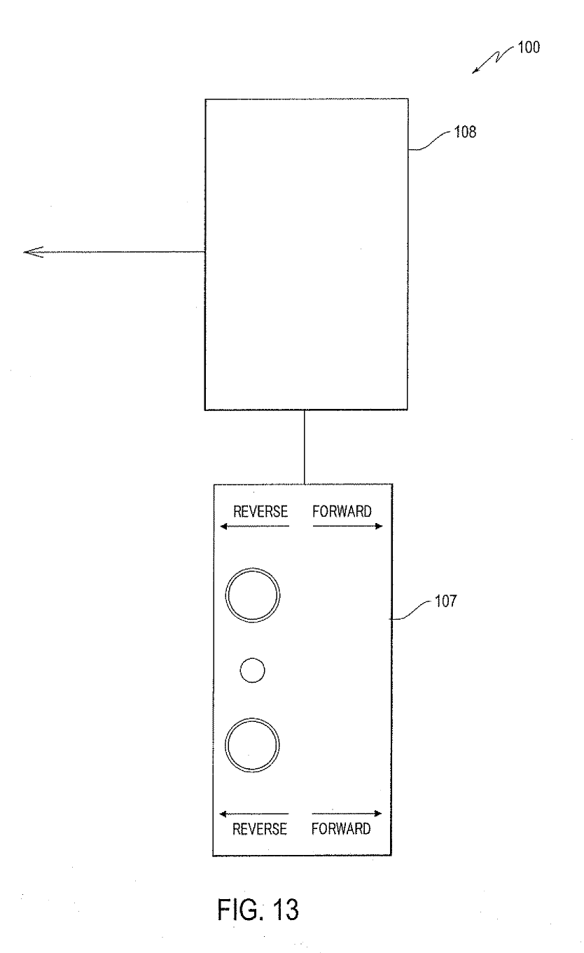

Referring to FIG. 13, a control system, such as control system 100, enables remote operation of the MAC 1. The control system can be electronic or hydraulic. In the embodiment illustrated in FIG. 13, the control system 100 includes a control box 107 and a microprocessor 108. The microprocessor 108 can be connected by wires to the manifold 29 for hydraulics or motors 27 if electric. Communication can also be achieved wirelessly with the motors 27.

An operator utilizes the control system 100 to operate the motors 27, to achieve the desired movement of the MAC 1. The operator inputs commands into the control box 107, which are processed and communicated to the motors 27 by the microprocessor 108.

The operation of the MAC 1 is described next.

As stated, the MAC 1 is powered by the motors 27. When operated, the motors 27 rotate their drive shafts 27a. Because the drive shafts 27a are connected to the drive shafts 80 of the drive shaft assemblies 59 of the tread assemblies 55, rotation of the drive shafts 27a causes rotation of the drive shafts 80. In turn, because the sprockets 82 are integral with or fixedly connected to the drive shafts 80, sprockets 82 are also rotated. Next, because sprockets 82 engage the tread driven chains 83 of the tread 63, the sprockets 82 drive the tread driven chains 83 in the direction of rotation of the sprockets 82. Finally, because the tread pads 79 are affixed to the tread driven chains 83 by the rods 85, the tread pads 79, and thus the entire tread 63, are driven in the direction of rotation of the sprockets 82.

The movement of the MAC 1 is dictated by the direction in which the treads 63 of the tread assemblies 55 of the track assemblies 11, 13, 17, 19 are driven. When the MAC 1 is to move in a given straight line, the treads 63 of the tread assemblies 55 of all the track assemblies 11, 13, 17, 19 are aligned and driven in that direction, at the same speed.

A change in direction of the MAC 1 can be achieved in various ways. One way is to drive the tread assemblies 55 of the track assemblies 11 and 19 in the opposite direction from which the tread assemblies 55 of the track assemblies 13 and 17 are being driven. For example, if the MAC 1 is moving in the direction shown by arrow 100 in FIG. 1, but it is desired to change the direction of the MAC 1 to a different lateral direction, the tread assemblies 55 of track assemblies 11 and 19 would be driven in the opposite direction from the direction in which the tread assemblies 55 of track assemblies 13 and 17 are driven, until the new desired direction is achieved. Once that new direction is achieved, the tread assemblies 55 of track assemblies 11, 13, 17, 19 are driven in the same direction at the same speed to move the MAC 1 in the new direction.

The movement of the tread assemblies 55 of track assemblies 11 and 19 in the opposite direction of the movement of the tread assemblies 55 of track assemblies 13 and 17, at the same speed, results in the MAC 1 having a zero or a near zero turning radius.

Another possible lateral movement of the MAC 1 is in an arc. This can be achieved in various ways. For example, movement in an arc can be achieved by having one pair of the tread assemblies 55 of the track assemblies, such as track assemblies 11 and 19, be stationary, while the tread assemblies 55 of track assemblies 13 and 17 move in the same direction.

Other lateral movements of the MAC 1 are possible by varying the speed of the tread assemblies 55 of the track assemblies 11 and 19 relative to the speed of the tread assemblies 55 of the track assemblies 13 and 17, even when the track assemblies 11, 13, 17, 19 are being driven in the same direction.

Next, the various axes of articulation of the MAC 1 are described.

The first articulating axis is axis X1, illustrated in FIGS. 4 and 6. Axis X1 is an axis through approximately the center of the extending portions 45 of the turntable base 4. The first main beam assembly 7 and the second main beam assembly 9 can rotate or articulate around axis X1. In fact, the first main beam assembly 7 and the second main beam assembly 9 can articulate independently from one another around axis X1. That independent articulation allows the MAC 1 to more readily move across uneven and/or sloped surfaces and also allows the MAC 1 to more readily overcome irregularities in the ground or other surface that it is traversing.

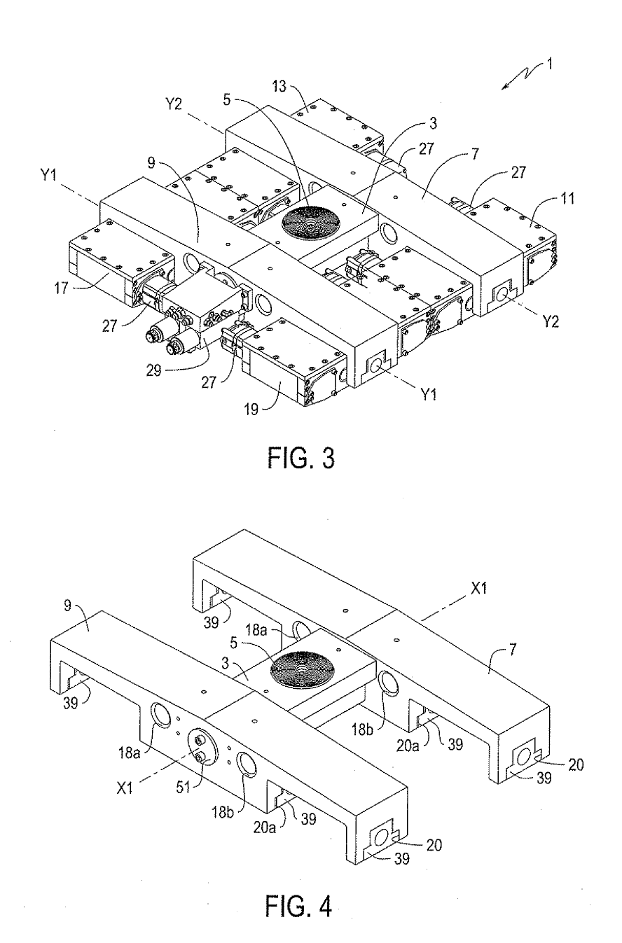

Other articulation axes include axes Y1 and Y2. See FIG. 3. Axis Y1 is the axis though approximately the center of the second main beam 9 that extends in the transverse direction. Axis Y2 is the axis through approximately the center of the first main beam 7 that extends in the transverse direction. The track assemblies 11 and 13 may rotate or articulate around axis Y2, and the track assemblies 17 and 19 may rotate or articulate around axis Yl. In fact, the track assemblies 11, 13, 17, 19 may articulate independently of each other around axes Y1 and Y2. For example, when the MAC 1 is on a flat surface but starts going up a slope in direction 100, the track assemblies 11 and 13 may articulate around axis Y2, such that their leading edges in (direction 100) rotate upward, without any articulation by the track assemblies 17 and 19 around axis Y1.

Having the track assemblies 11, 13, 17, 19 articulate around axes Y1 and Y2 allows the MAC 1 to more readily move across uneven surfaces and also allows the MAC 1 to more readily overcome irregularities in the ground or other surface that it is traversing, because it maximizes the contact of the treads 63 of the tread assemblies 55 of the track assemblies 11, 13, 17, 19 with the ground or other surface.

Additional axes of articulation are illustrated in FIG. 9, axes X and Y. These axes of articulation are present in each roller pack assembly 61. Specifically, each roller pack assembly 61 has an X axis of articulation on the axis of main pivot block 65 and a Y axis of articulation on the axis of central shaft 73. As discussed above, the forward axle 67 and the aft axle 68 can articulate around axis Y. Essentially, the X axis of articulation functions as a pitch axis and the Y axis of rotation functions as a roll axis. Due to the inclusion of axes X and Y, each of the bearing elements 69 on the forward axle 67 and the aft axle 68 can contact the tread 63 independently of the other bearing elements 69.

The combination of the X and Y axes of articulation and the forward and aft axles 67 and 68 results in improved bearing contact between the treads 63 of the tread assemblies 55 and the ground or other surface that the MAC 1 is traversing when the ground or other surface is uneven due to, for example, grade changes for drainage, transitions to slopes or ramps, transitions on or off of a steel plate, travelling over expansion gaps or joints, etc. Specifically, each roller assembly 61 will rotate around its X and Y axes as the MAC 1 traverses uneven ground or other surface. That rotation around the X and Y axes will cause the appropriate bearing elements 69 to “push” the tread 63 into contact with the ground or other surface the tread 63 is traversing to maximize the contact of the tread 63 with the ground or other surface.

Due to the arrangement of the turntable assembly 3, first and second main beam assemblies 7 and 9, track assemblies 11, 13, 17, 19 and motors 27 described above and illustrated in the Figures, the height of the illustrated MAC 1 may be relatively low. Additionally, the MAC 1 may carry loads of up to 100 tons due to its structural strength.

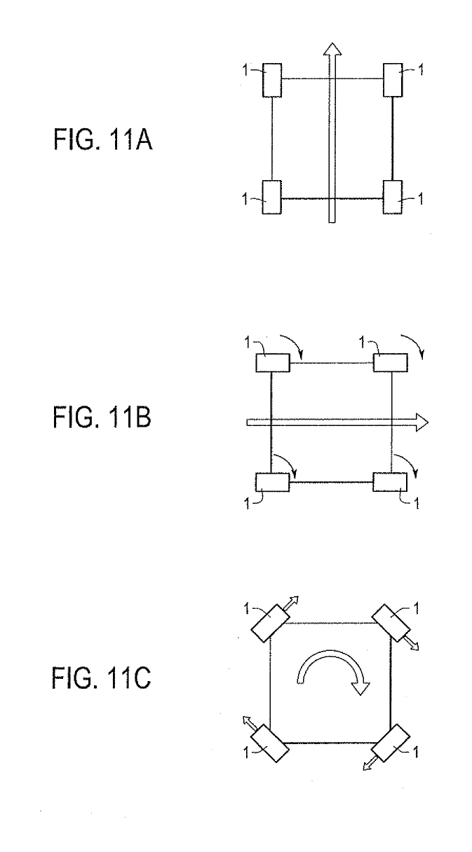

More than one MAC 1 can be used to transport a given load. This is illustrated in FIGS. 11A-11C. Specifically, FIGS. 11A-11C illustrate the use of four MAC 1's to transport a load. The four MAC 1's are arranged as the four corners of a square. In FIG. 11A, the load is being transported in a given lateral direction, shown by the arrow. All four MAC 1's are moving in the same direction, at the same speed.

If it is desired to transport the load in a different lateral direction, each of the track assemblies 11, 13, 17, 19 of the MAC 1's is rotated (as described above) to be oriented in the new direction, such as illustrated by FIG. 11B. The four MAC 1's can then transport the load in the new direction shown in FIG. 11B by moving the four MAC 1's in that direction, at the same speed.

If it is desired to rotate the load, the tracking assemblies 11, 13, 17 and 19 of the four MAC 1's can be oriented as shown by FIG. 11C, and each MAC 1 can move in the desired arc.

The four MAC 1's in FIGS. 11A-11C can be operated by a central control system, such as control system 100. Position data may be provided by each of the four MAC 1's to the central control system. The control system may independently operate each of the four MAC 1's based on the position data from each of the four MAC 1's and the desired movement as input by the operator.

What has been described and illustrated herein are preferred embodiments of the invention along with some variations. The terms, descriptions and figures used herein are set forth by way of illustration only and are not meant as limitations. Those skilled in the art will recognize that many variations are possible within the spirit and scope of the invention, which is intended to be defined by the following claims—and their equivalents—in which all terms are meant in their broadest reasonable sense unless otherwise indicated.

What is claimed is:

1. A crawler comprising:
a load support;
a first arm rotatably attached to the load support and located on one side of the load support;
a second arm rotatably attached to the load support, the second arm being located on the opposite side of the load support from the first arm, the second arm being capable of rotation relative to the load support independent of the rotation of the first arm relative to the load support;
first and second spaced track assemblies rotatably attached to the first arm; and
third and fourth spaced track assemblies rotatably attached to the second arm;
wherein the axis of rotation of the first arm relative to the load support is parallel to the axis of rotation of the second arm relative to the load support;
wherein the axes of rotation of the first and second track assemblies relative to the first arm are perpendicular to the axes of rotation of the first and second arms relative to the load support;
wherein the axes of rotation of the third and fourth track assemblies relative to the second arm are perpendicular to the axes of rotation of the first and second arms relative to the load support; and
wherein the first, second, third and fourth track assemblies extend below the load support and the first and second arms.

2. A crawler according to claim 1, wherein
the load support includes a turntable, the turntable defining the uppermost surface of the load support and extending above the first arm, the second arm, and the first, second, third and fourth track assemblies.

3. A crawler according to claim 1, wherein
the axes of rotation of the first arm and the second arm relative to the load support are the same.

4. A crawler according to claim 3, wherein
the first arm is an elongated arm having a longitudinal axis and the second arm is an elongated arm having a longitudinal axis;
the longitudinal axis of the second arm is parallel to the longitudinal axis of the first arm; and the longitudinal axis of the second arm is located on the opposite side of the load support from the longitudinal axis of the first arm; and
the axes of rotation of the first and second arms relative to the load support are perpendicular to the longitudinal axes of the first and second arms.

5. A crawler according to claim 4, wherein
the first and second track assemblies have the same axis of rotation relative to the first arm; and
the third and fourth track assemblies have the same axis of rotation relative to the second arm.

6. A crawler according to claim 5, wherein
the first, second, third and fourth track assemblies each include a tread assembly having a longitudinal axis in the direction of movement of the tread assembly;
the longitudinal axes of the tread assemblies of the first and third track assemblies are the same line; and
the longitudinal axes of the tread assemblies of the second and fourth track assemblies are on the same line.

7. A crawler according to claim 6, wherein
the first and third track assemblies are located on an opposite side of the load support from the second and fourth track assemblies.

8. A crawler according to claim 7, wherein
the longitudinal axes of the tread assemblies of the first and third track assemblies is parallel to the longitudinal axes of the second and fourth track assemblies.

9. A crawler according to claim 8, wherein
the longitudinal axes of the tread assemblies of the first, second, third and fourth track assemblies are perpendicular to the longitudinal axes of the first and second arms.

10. A crawler according to claim 9, wherein
each of the tread assemblies of the first, second, third and fourth track assemblies includes a drive roller, at least one other roller, and a continuous tread;
the continuous tread forming a loop around the drive roller and the at least one other roller;
the continuous tread is comprised of a continuous series of elongated tread pads arranged in parallel; and
the tread pads are perpendicular to the longitudinal axis of the tread assembly.

11. A crawler according to claim 10, further comprising motors that drive the drive rollers of the tread assemblies.

12. A crawler according to claim 11, wherein
each of the first, second, third and fourth track assemblies includes a frame that partially encloses the tread assembly;
the frame including a rod that is rotatably received by one of the first arm and the second arm; and
the drive roller and the at least one other roller being rotatable relative to the frame.

13. A crawler according to claim 12, wherein
the drive roller, the at least one other roller and the rod have parallel axes; and the axis of the rod is located between the axes of the drive roller and the at least one other roller.

14. A crawler according to claim 13, wherein
each of the tread assemblies of the first, second, third and fourth track assemblies further comprises a roller pack assembly located within the loop formed by the continuous tread;
the roller pack assembly being rotatable about a pitch axis and a roll axis;
the pitch axis being spaced from but parallel to the axis of rotation of the drive roller and the roll axis being perpendicular to the pitch axis;
the roller pack assembly includes bearing members that rotate about axes parallel to the pitch axis and can selectively engage the tread.

15. A crawler according to claim 14, wherein
the roller pack assembly includes a central rod that extends the width of the frame and has ends that are rotatably received by the frame, the central rod defining the pitch axis;
the roller pack assembly also includes forward and aft axles on opposite sides of the central rod; and
the central rod, the forward axle and the aft axle having longitudinal axes located in parallel planes.

16. A crawler according to claim 15, wherein
the roll axis is defined by a shaft passing through the central rod, the forward axle and the aft axle.

17. A crawler according to claim 16, further comprising a controller that is remote from the load support, the first and second arms and the first, second, third and fourth track assemblies.

18. A crawler comprising:
a turntable assembly having a turntable;
a first main beam rotatably coupled to a first side of the turntable base such that the first main beam has a first axis of articulation relative to the turntable base;
a second main beam rotatably coupled to a second side of the turntable base such that the second main beam has the first axis of articulation relative to the turntable assembly;
a first pair of track assemblies rotatably coupled to the first main beam such that the first pair of track assemblies has a second axis of articulation relative to the first main beam; and
a second pair of track assemblies rotatably coupled to the second main beam, such that the second pair of track assemblies has a third axis of articulation relative to the second main beam;
wherein the second and third axes of articulation are parallel and perpendicular to the first axis.

19. The multi-axis articulating crawler of claim 18, wherein the first pair of track assemblies and the second pair of track assemblies are configured to articulate independently from one another.

20. A crawler comprising:
a load support having a longitudinal axis and a lateral axis;
first and second elongated arms rotatably attached to the load support, the first and second elongated arms being on opposite sides of the longitudinal axis of the load support, the first and second elongated arms being independently rotatable with regard to the load supports, the first and second elongated arms having parallel longitudinal axes;
first and second spaced track assemblies rotatably attached to the first elongated arm, said first track assembly being located on the opposite side of the lateral axis of the load support from the second track assembly;
third and fourth spaced track assembles rotatably attached to the second elongated arm, side third track assembly being located on the opposite side of the lateral axis of the load support from the fourth track assembly;
wherein the axes of rotation of the first, second, third and fourth track assemblies are perpendicular to the axes of rotation of the first and second elongated arms relative to the load support;
wherein the first, second, third and fourth track assemblies extend below the load support and the first and second elongated arms.

21. The crawler according to claim 20 wherein:
The first and second elongated arms have the same axis of rotation relative to the load support.
